(19) United States
(12) Patent Application Publication
(10) Pub. No.: US 2017/0092323 A1
(43) Pub. Date: Mar. 30, 2017

(54) Audio/Video Merge Tool

(71) Applicant: Paul Goldman, New York, NY (US)

(72) Inventor: Paul Goldman, New York, NY (US)

(21) Appl. No.: 14/644,033

(22) Filed: Mar. 10, 2015

Related U.S. Application Data
(60) Provisional application No. 61/950,372, filed on Mar. 10, 2014.

(51) Int. Cl. G11B 27/031; G06F 17/30; G06F 3/0484; G11B 27/10; G06F 3/0482

(52) U.S. Cl. CPC G11B 27/031; G11B 27/10; G06F 3/0482; G06F 3/04842; G06F 17/30864; G06F 17/30023

(57) ABSTRACT

A tool for merging audio and video files on a computer. The tool allows a user to select from a source, one or more audio files and one or more video files, and save the said files to a memory on the said computer using a computer program with a compatible user interface. The user then selects portions of said audio files via the computer program and user interface and arranges them into an ordered audio stream. In some embodiments, the audio file is visually represented to aid the user in selecting the desired portions. The user also selects portions of said video files via the computer program and interface and arranges them into an ordered video stream. The user can then merge the said audio and video streams into one integrated file, creating a final music video or other medium that can be displayed, shared or stored.

### FIELD OF THE INVENTION

The present invention relates to a platform for combining a video or still photograph component and audio component for a combined audio/video clip. Specifically, it is a music video merging platform from which video clips can either be created or synchronized to music. The present invention allows a user to select a video or one or more still photographs from a video library or the internet, and one or more audio clips, whether entire songs or selected parts of a song, and synchronize a segment of a song or music clip with the selected video image or set of images.

### BACKGROUND OF THE INVENTION AND DISCLOSURE

Many users keep audio libraries on their cell phones, computers, iPads, or other electronic devices to store a collection of songs for playing. This can include iTunes, Windows Media Library, or any other library of music which can be stored electronically. It is also common for users to have photo or video libraries on those same devices for selection of one or more photographs or videos to be displayed, including Facebook, Instagram, a phone's camera roll, or a folder of photographs on a computer.

The present invention provides an audio and video merge platform for use on a computer, smartphone, tablet, or other electronic device which allows a user to visually display one or more photographs or videos and simultaneously and synchronously aurally project a song. The merge platform enables a user to upload one or more videos or still photographs and arrange a plurality of images in any order desired. The user can also upload one or more audio clips, such as entire songs or segments of a song, and arrange the audio clips in any desired fashion. Finally, the audio and video clips can be synchronized by a user so that music can be played to synchronize with the sequence of video or photographic images selected and organized by a user. By using the merge tool of the present invention, a user can create merged audio/video clips which include selected video and selected audio overlaid on one another for simultaneous and synchronized visual and aural projection.

The present inventive merge tool preferably comprises a back end database which is tagged to access music preferably stored in the database but is also preferably adapted to access music from various sources on the internet. This back end database is also configured to provide a visual representation of sound waves which correspond to audio clips being played. In this manner, a user can maneuver his cursor over the sound wave image to select a first specific point, corresponding to second, segment, or moment in a song, from which he wishes to begin the music clip. Then, the user can likewise select a second specific point of the visual and aural sound wave, corresponding to a different second, segment, or moment in the song, to end the audio clip. That selected audio segment can then be overlaid onto a selected photograph or group of photographs, such as in a slideshow, or onto a video clip. Use of the merge tool without the visual sound wave representation is also envisioned, though use thereof is preferred to provide precision and ease of specification for the desired audio clip.

A user can create a compilation of audio clips—whether multiple components of a single song or a composite of clips from different songs—which can be combined for playing along with a photo, video or slideshow of photos. Rather than a professional music video, which creates a visual image and video to match a song, the present invention allows a user to create a musical composition of one or more previously created songs—or clips thereof—and synchronize the same with an already-created or simultaneously-created photograph or video clip.

The present invention preferably comprises a keyword search engine function which allows a user to find and select music of his choosing. This search engine allows a user to find and incorporate a song from a source on the internet, should the merge tool be used on a computer or electronic device connected to the internet, and should a desired song not already exist in the user's personal audio libraries. Additionally, the present invention preferably comprises a link by which a user, after creating a video and audio merge of his choosing, can upload that video to be shared with others, such as friends, or can post the same on the internet.

Another inventive aspect of the preferred embodiment of the present invention is that the audio segment and the video segment are not interdependent. This means that, unlike in most prior art audio/video systems, the visual aspect and the aural aspect of the present invention are capable of running independent of one another, as they both are taken from an already-existing and independent source. Thus, the audio segment is not driven by the video segment, and the video segment is not driven by the audio segment. They are, at all points during use, two distinct components which are overlaid against one another and synchronized by means of the present invention to project and be sensed simultaneously. Once overlaid, the independent audio and video segments become synchronized, and thus will play simultaneously. However, the segments remain independent, and thus any or all parts of the compiled clip can be amended or removed, or additional components can be added, if a user decides to change one or more aspects of his compiled audio/video clip. It is, however, also envisioned in an alternate embodiment of the present invention that the audio and video segments could be combined into one single and final file.

With the video merge tool of the present invention, a user can upload an already-existing video to the platform, search for and select one or more pieces of music, demo the music against the pictures or video uploaded, and then merge it into a finished audio/video clip. From there, a user is able to email the created audio/video clip to a friend, or upload it to the Internet preferably via YouTube, Facebook, or other social networking sites for sharing with others.

The present invention also comprises a new search engine logarithm, preferably called Elastic Search. The search engine is a full search solution preferably built on top of an open-source full-text search engine such as Apache Lucene. Primarily, the search engine does the task of “indexing data,” which most databases are adapted to do. This particular database, however, preferably allows searching to be run faster, and is adapted to analyze sentences into terms, store the terms, and retrieve the terms when the user searches for them. Each of these simple steps has many parts to it which can be fully customized and described by a programmer.

As an example of how the search engine of the present invention is run, a user can enter text, such as a keyword or name, and a “wildcard” query can be run on that word, meaning that any result in which that word appears, whether alone or amongst other words, will appear in the results. For example, the term *Happy* can be entered into the query, and the results might show “Happy Birthday,” “Mike's Happy Birthday,” or just “Happy.” That query can be run against track titles, tag names, and artist names for songs of the user's choosing. All results which include the keyword entered into the query will preferably appear in the results of the search.

The query results can then preferably be broken up into four categories: 1) exact tag matches in the tag's category; 2) parent tag matches in the tag's category; 3) exact matches in the root tag category; and 4) parent matches in the root tag category. Once the query and search filters are set up and run, the results will be entered into the search engine database for selection by a user. After the query is finished, results can be run through filters which score the results based on their match to the queried terms and rank the results. Search results are preferably given point values based on their closeness to the queried terms.

Additionally, the present invention is preferably adapted to comprise a purchase mechanism for individuals to purchase merged videos previously created by a user, and pay a royalty to that user accordingly. When a user clicks to make a purchase, the present invention is preferably adapted to automatically pay all composers, publishers, and writers, as well as notify the Performance Rights Organization of record (ASCAP, BMI, SESAC) of such purchase. Preferably, the present invention could be connected to a PayPal account so that individuals can receive royalty payments when their created videos are online and viewed by others. Composers and video creators can thus instantly see money in their PayPal accounts linked to the present invention.

The present invention also preferably comprises tools common to music players such as the ability to create playlists and see a history of recent searches. However, the present invention also comprises a unique set of tools allowing users to search for videos and songs, upload their videos, demo music against picture uploaded, and then merge video and music together creating finished projects. From there, users may be able to download, email, or post finished merged videos directly to their favorite online platforms such as YouTube, Vimeo and Facebook.

### DESCRIPTION OF PRIOR ART

To the Applicant's knowledge, there are no audio and video merge tools in the prior art which allow a user to select one or more video clips or still photographs, to be arranged in any particular order desired by a user, and to select one or more songs or audio clips, which can then be modified and/or cut down based on a user's desire to utilize only certain segments of one or more songs, and which then can be merged together into a unified and synchronized audio and video clip. There is no prior art to the Applicant's knowledge which provides a platform to allow a user to create a combined audio and video clip which can be made up of segments of a multitude of songs, selected by a user, and overlaid onto video or photographs supplied by the same user. The prior art, to the Applicant's knowledge, also does not teach or suggest a merge tool for the preparation of joint audio and video clips which provides the use of independently driven audio and video segments which are adapted to run synchronized with one another.

### SUMMARY OF THE INVENTION

The present invention relates to an audio/video merging platform that enables users to upload one or more songs or audio clips of their choosing from a back end server of the present invention using the search engine of the present invention, and also preferably from other sources such as an audio library such as iTunes, Windows Media Player, or any other library, and select segments of the one or more songs for combining the same into an audio clip. The present invention also allows users to select one or more photographs or video segments, which can be uploaded from any photo library such as Facebook, Instagram, a camera roll, a cloud server, or even a folder on a desktop. The photos or video clips can be arranged in any order desired by a user, such as in a slideshow. A user can even select portions of the video clip for use therewith.

A user can upload selected songs into the present inventive merging platform, and select specific segments of those songs which he or she wishes to use in the final audio/video clip, which can then be arranged in any order of his or her choosing. Alternatively, the inventive merging platform can include a curation algorithm that will automatically create a playlist based on the pace, mood, or style of the video using the pace, mood, artist, popularity, or other information of particular songs. In either embodiment, the songs or song clips can then be overlaid onto the photos or video selected and uploaded by the user for a combined audio/video clip created entirely by the user.

### BRIEF DESCRIPTION OF THE DRAWINGS

FIG. 1 is a screenshot of the present invention, an audio/video merge tool, showing the option for a user to select a video from a video library connected to the present invention, and to search for and select one or more songs to be overlaid and synchronized with the selected video;

FIG. 2 is a screenshot of the present invention seen in FIG. 1, showing the option for a user to select a segment of a selected song to be included in the audio/video clip created by the present invention, which can then be overlaid onto a previously selected video clip;

FIG. 3 is a flowchart showing the progression of a wildcard query search on the present inventive search engine, showing the varying search results possible and the point values associated with each by utilizing this search engine;

FIG. 4 is a screenshot of the present invention showing a detailed view of the search function with a possible search, search results, and a song selection; and

FIG. 5 is a screenshot of the present invention showing the finished merged video and audio with the option for a user to share the video with friends.

FIG. 6 is a flowchart showing the flow of data related to song or song segement files used in the automatic curation algorithm.

### DETAILED DESCRIPTION OF THE DRAWINGS AND THE PREFERRED EMBODIMENT

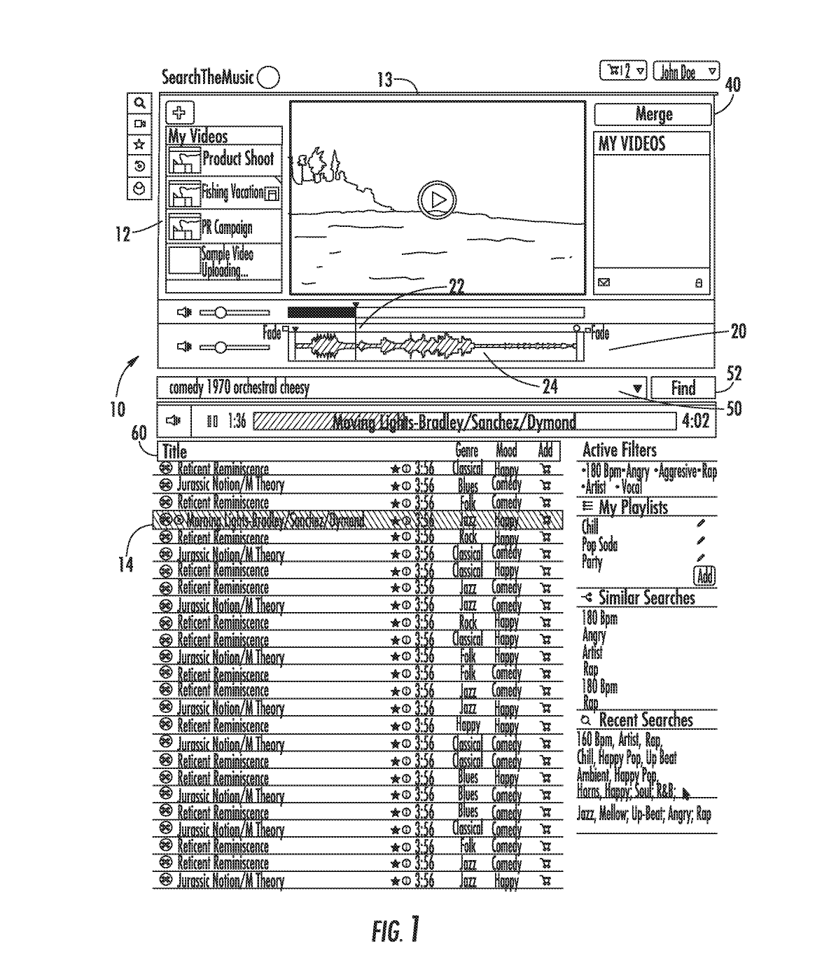

Description will now be given of the invention with reference to the attached FIGS. 1-5. It should be understood that this figure is exemplary in nature and in no way serves to limit the scope of the invention.

The present invention discloses an audio/video merge tool which allows a user to upload one or more photographs or videos and one or more songs or audio clips onto the merge platform, which can be aurally and visually displayed or used on a computer, smartphone, tablet, or other electronic device. The merge platform 10 enables a user to upload one or more videos or still photographs 12 and arrange a plurality of images in any order desired. The video can be played in video player 13. The user can then upload one or more audio clips 14, such as entire songs or one or more song clips, and arrange the audio clips in any desired fashion. This enables a user to simultaneously play a video clip 12 and an audio clip 14 to determine desired synchronization. In the preferred embodiment of the present invention, the audio clips 14 and video clips 12 are configured to run simultaneously yet independently of one another. In an alternate embodiment, it is also envisioned that the audio clip 14 and video clip 12 can be combined into a single file.

The present inventive merge tool 10 preferably comprises a visual representation of sound waves 24 to represent volume, bass, frequency, etc. of the songs being played. In this manner, a user can maneuver his cursor 22 over the sound wave image 24 to select a first specific moment in a song, from which he wishes to begin a music clip. The visual representation 24 provides an image by which a user can visualize the beats and tempo of a selected song 14, which may help a user locate a specific moment in the song which he wishes to use as the beginning of audio clip 28. While the visual representation 24 is preferred, it is not required for the present invention.

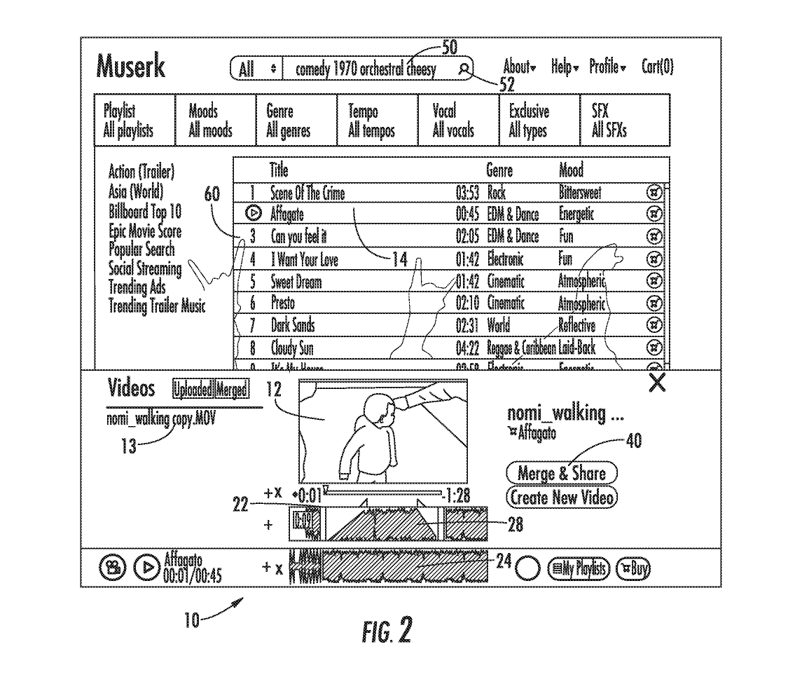

Then, using the visual representation 24 and cursor 22, the user can likewise select a second specific point, corresponding to a different moment in that song, to end the audio clip. That selected audio segment can then be overlaid onto a selected photograph or group of photographs, such as in a slideshow, or onto a video clip. The selected song 14 can be added into the audio player 20. A user can then listen to the song 14 and select a segment in the song which the user wishes to utilize for the video merge. This can be seen in FIG. 2.

Once a user has selected a segment 28 of a song 14 which he wishes to add to a video, he can play the video 12 and select the moment in the video which he wishes to begin the selected audio clip 28. Once ideal synchronization is achieved, the user can merge the two into a single audio/video clip, using the “Merge” button 40. This preferably creates a single merged and synchronized video 30 which combines the selected video clip 12 and the selected music 14. By using the merge tool 10, a user can arrange photos or video clips in any order of his choosing, and then overlay the audio clips onto the video to match up visual and aural display.

The present invention preferably comprises a keyword search function 52 which allows a user to find and select music of his choosing. This can allow a user to find a clip of a song on the internet 14, should the merge tool be used on a computer or electronic device connected to the internet and should a song desired by the user not already exist in his or her personal audio libraries. A user can select one or more songs from a list of results in response to his search, and then use the visual representation 24 and cursor 22 to select segments 28 of songs 14 for use with the selected videos 12.

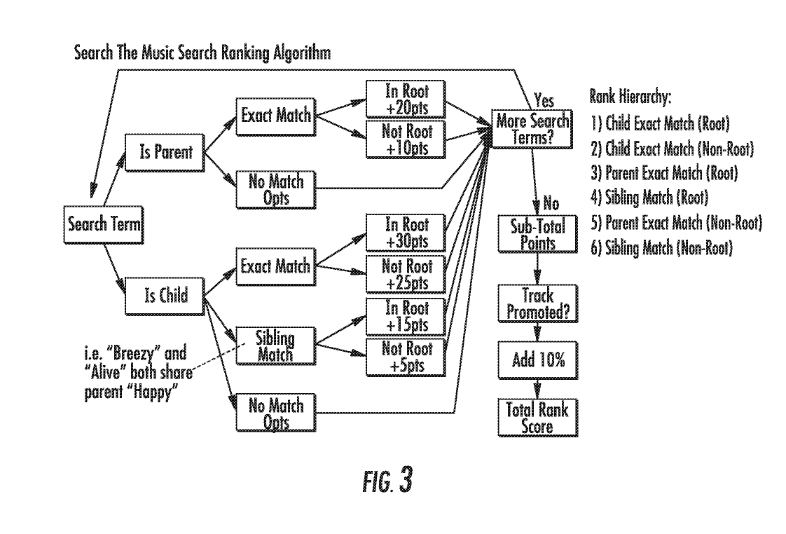

The present invention preferably comprises a new search engine algorithm which allows a user to enter text, such as a keyword or name, into the search field 50. A “wildcard” query is run on that word, meaning that any result in which that word appears, whether alone or amongst other words, will appear in the results. How the algorithm ranks and selects related terms and songs is shown in FIG. 3. This query can be run against track titles, tag names, and artist names for songs of the user's choosing. All results which include the keyword entered into the query appear in the results of the search.

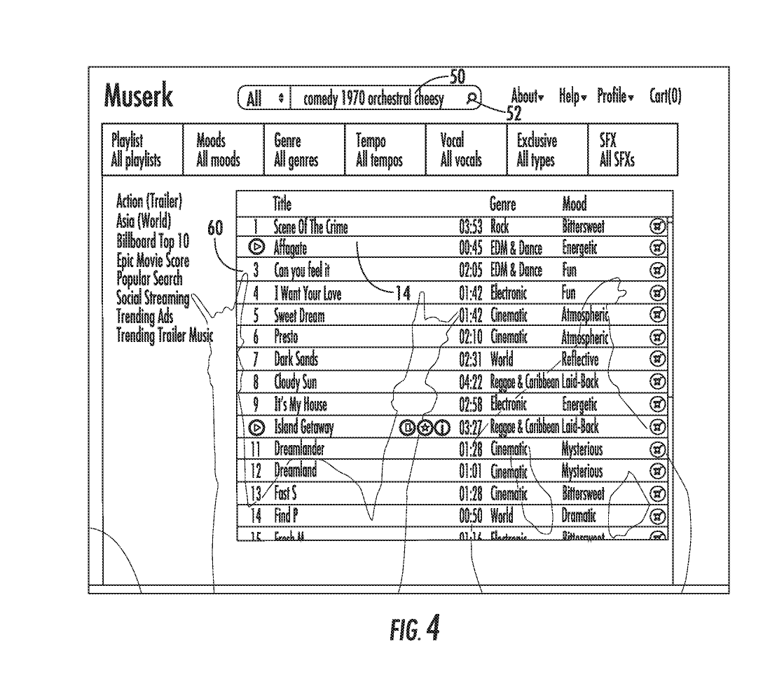

An example of the search run by the present invention can be seen in FIG. 4. The query results are then preferably broken up into four categories: 1) exact tag matches in the tag's category; 2) parent tag matches in the tag's category; 3) exact matches in the root tag category; and 4) parent matches in the root tag category. Once the query and search filters are set up and run, the results can be entered into the search engine for selection by a user. All results from the search will preferably appear in the results list 60. From this list, a user can select one or more songs for inclusion in the merged audio/video clip.

A user can preferably select segments of multiple songs to create a compilation of audio clips which can be combined for playing along with a video or slideshow of photos. Rather than a professional music video, which creates a visual image and video to match a song, the present invention allows a user to create a musical compilation of one or more songs or audio clips to synchronize with an already-created or simultaneously-created video clip.

Alternatively, a user can choose to select the music via an automatic curation algorithm provided in the present inventive merge tool. The automatic curation algorithm will, based on a user's preferences, automatically select audio clips 14 from a pool of audio clips to accompany the video clip 12. Thus, with this option, a user will not need to decide exactly which song(s) or segment(s) to include, but can instead simply choose a mood, style, or artist. A user's preferences might include, for example, narrowing the pool of audio clips to songs or segments that are from a specific time period, of a certain genre, by a specific artist, or any other criteria a user deems relevant such as the current Billboard Chart ranking or number of Spotify streams. In preferred embodiments, a user can narrow the pool of audio clips via filter or search options built into merge tool 10.

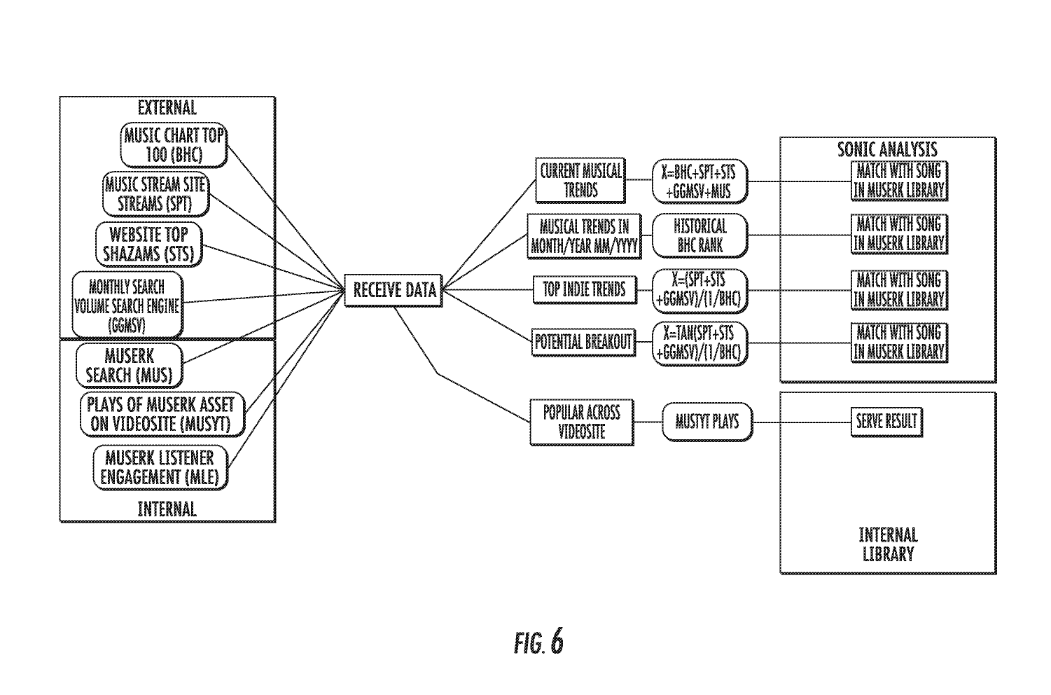

Each file in the pool of available audio clips is categorized prior to the filtering or the search based on live input of public data and propriety user data to include information that might be relevant to the automatic curation algorithm. As seen in FIG. 6, this data can reflect real time trends, change in trends, or historical information, among other qualities. In some embodiments, the invention will use data mining techniques to gather further information about files, segments, and libraries. In these embodiments, the audio clips will also undergo a sonic analysis to recognize musical characteristics of the files such as beats per minute, chord progression, dynamic range, dynamic peaks, frequency range, and amplitude to categorize the mood, tempo, and style of the audio content.

Similarly, in order for the video clips 12 to be automatically synchronized to the audio clips 14, the video clips also undergo an analysis. The video clips are analyzed to recognize visual characteristics that might affect the flow of the video and therefore the compatibility with the audio clips. Such characteristics can include, for example, frequency of cuts, duration of cuts, and movement. The synchronization process then compares the musical qualities of the audio clips 14 in the pool of audio clips, or narrowed pool of audio clips, to the visual characteristics of the video clips 12. Audio clips 14 with similar pace, mood, style, etc. will be automatically selected without further input from the user to form a playlist to be synchronized with the video clips 12.

When a user has selected a video clip 12 and an audio clip 14, or an audio clip 14 has automatically been selected, for combination into a final merged video 30, he is able to create a single merged video 30 which can then be shared with others though email or internet on sites such as Facebook or YouTube.

In the preferred embodiment of the present invention, the audio segment 28 and the video segment 12 remain independent from one another even though a single merged video 30 is created by the present inventive merge tool 10. This means that the video 12 and song 14 are capable of running independently of one another, as they both are taken from an already-existing source. Thus, the audio segment is not driven by the video segment, and the video segment is not driven by the audio segment. They are, at all points during use, two distinct components which are overlaid against one another by means of the present inventive merge tool 10. Once overlaid, the independent audio and video segments become synchronized, and thus will play simultaneously. However, the segments remain independent, and thus any or all parts of the compiled clip can be amended if a user decides to change one or more aspects thereof. However, it is also envisioned that the audio segment 28 and video segment 12 can be merged into a single new file.

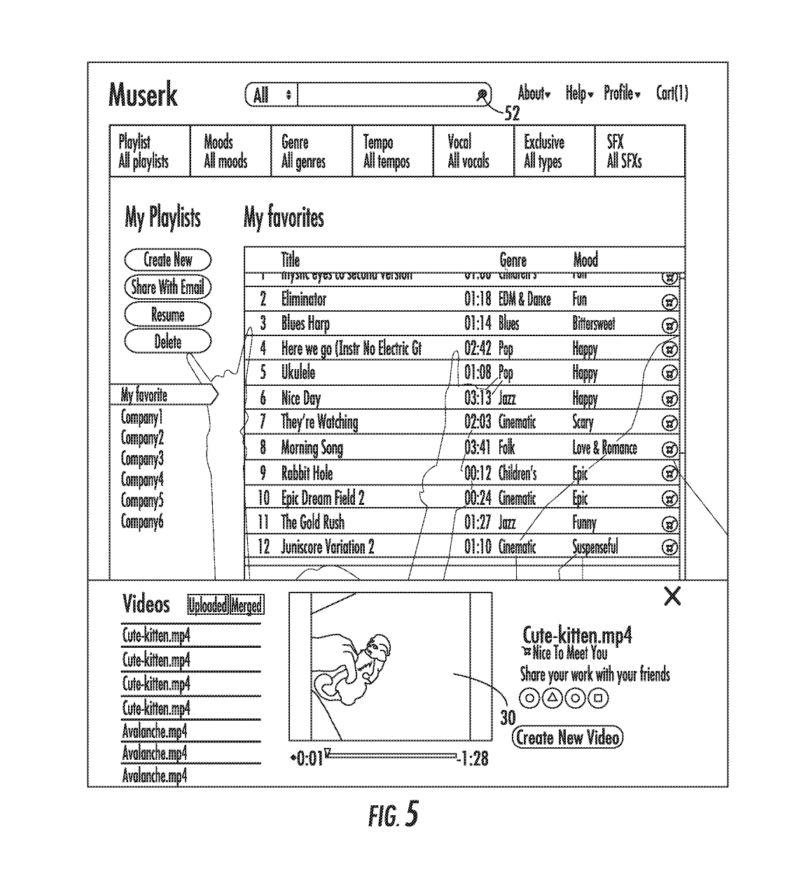

The present invention allows a user to create a merged video with overlaid audio clips. Once a final merged audio and video 30, shown in FIG. 5, is created using the merge button 40, a user can upload the new file online, such as to YouTube or Facebook, or email it to friends. The present invention also preferably provides a tool which provides royalty payments to a composer/user should his created merged videos be bought or listened to by others once posted online. Preferably, the present invention could be connected to a PayPal account so that individuals can receive royalty payments when their previously-created videos are viewed by others.

What is claimed is:

1. A tool for merging audio and video files comprising:
a computer having a memory and processor;
a computer program executable on said computer;
at least one computer file containing video content stored in said memory and at least one computer file containing audio content also stored in said memory;
wherein a user, via said computer program, locates and selects at least one portion of said video files and at least one portion of said audio files, arranges said portions of said video files in an order of his choosing, creating a video stream, and arranges said portions of said audio files in an order of his choosing creating an audio stream; and
wherein the said program plays the audio stream simultaneously with the video stream as integrated audio and video stream.

2. A tool as claimed in claim 1 wherein said audio content is able to be visually represented by the beat and/or tempo in said audio file.

3. A tool as claimed in claim 2 wherein a user can specify a beginning and/or end point in the audio file via the said visual representation.

4. A tool as claimed in claim 1 wherein the said program plays the audio stream simultaneously with the video stream as one merged audio video stream.

5. A tool as claimed in claim 1 further comprising a mechanism for financially compensating artists of said video or audio content.

6. A tool as claimed in claim 1 wherein the said integrated audio and video stream synchronizes and combines the said audio and video streams into one file containing segments from both the said audio and video files.

7. A tool for merging audio and video files comprising:
a computer having a memory and processor;
a computer program executable on said computer;
at least one computer file containing video content storable in said memory;
at least one computer file containing audio content storable in said memory;
wherein a user, via said computer program, locates and selects said video and audio files, selects at least one portion of at least one of said video file, selects at least one portion of at least one of said audio file, arranges said video portions in an order of his choosing, creating a video stream, arranges said audio portions in an order of his choosing creating an audio stream; and
wherein the said program projects said audio stream simultaneously with the said video stream.

8. A tool as claimed in claim 7 wherein said audio content is able to be visually represented by the beat and/or tempo in said audio file.

9. A tool as claimed in claim 8 wherein a user can specify a point in the audio file via the said visual representation.

10. A tool as claimed in claim 9 further comprising a mechanism for financially compensating artists of said video or audio content.

11. A tool as claimed in claim 7 wherein said audio file is obtained from an external source other than the said memory of said computer.

12. A tool for merging audio and video files comprising:
a computer having a memory and processor;
a computer program executable on said computer;
at least one computer file containing video content storable in said memory;
at least one computer file containing audio content storable in said memory;
information regarding the visual qualities of the said video content;
information regarding the musical qualities of the said audio content;
wherein a user, via said computer program, locates and selects at least one portion of at least one of said video files, and arranges said video portions in an order of his choosing to create a video stream;
wherein the said program, using said information regarding said visual qualities and said information regarding said musical qualities, matches at least one of said audio files to the selected video stream; and
wherein the said program plays the audio stream simultaneously with the video stream as integrated audio and video stream.

13. A tool as claimed in claim 12 further comprising a mechanism for financially compensating artists of said video or audio content.

14. A tool as claimed in claim 12 wherein said audio file is obtained from an external source other than the said memory of said computer.

15. A tool as claimed in claim 12 wherein the said integrated audio and video stream synchronizes and combines the said audio and video streams into one file containing segments from both the said audio and video files.
